(19) United States
(12) Patent Application Publication
(10) Pub. No.: US 2026/0274121 A1
(43) Pub. Date: Sep. 17, 2026

(54) SEATBACK LOCK DEVICE AND VEHICLE SEAT

(71) Applicants: NHK SPRING CO., LTD., Yokohama-shi (JP); SUBARU CORPORATION, Tokyo (JP)

(72) Inventors: Jun AOKI, Yokohama-shi (JP); Tomoya TAKAHASHI, Yokohama-shi (JP); Yosuke ISHIYAMA, Tokyo (JP); Taiki ONO, Tokyo (JP)

(21) Appl. No.: 19/567,700

(22) Filed: Mar. 16, 2026

(30) Foreign Application Priority Data
Mar. 17, 2025 (JP) 2025-042956

(51) Int. Cl. B60N 2/22

(52) U.S. Cl. CPC B60N 2/2245

(57) ABSTRACT

A seatback lock device including a lock main body that is attached to a frame of a tiltable seatback and that engages with a striker provided at a vehicle body, a release lever coupled to the lock main body, that releases engagement between the lock main body and the striker by being displaced toward a seat upper side, and that also includes a strap coupling portion extending diagonally toward the seat width direction inner side and the seat upper side, and a strap having a one-end portion that is coupled so as to be able to rotate with respect to the strap coupling portion and an other-end side arranged along a height direction of the seatback due to the strap being folded at an obtuse angle at an intermediate portion of the strap, with the other-end portion inserted through a strap pull-out opening formed in a shoulder of the seatback.

### CROSS-REFERENCE TO RELATED APPLICATION

This application is based on and claims priority under 35 USC 119 from Japanese Patent Application No. 2025-042956 filed on Mar. 17, 2025, the disclosure of which is incorporated by reference herein.

### BACKGROUND

### Technical Field

The present disclosure relates to a vehicle seat, and in particular relates to a seatback lock device.

### Related Art

A lock device for use in a forward tiltable seatback is disclosed in Japanese Patent Application Laid-Open (JP-A) No. 2003-170767. A one-end portion of a strap is coupled to a release lever of this lock device. An other-end side of the strap is inserted into a strap pull-out opening (insertion hole) provided at a shoulder of the seatback. Locking of the lock device is configured so as to be released by pull-operation of this strap.

### SUMMARY

In related art such as described above, for example, the one-end portion of the strap is coupled so as to be able to rotate with respect to the release lever using a rivet, and also sometimes the strap pull-out opening is arranged displaced to a seat width direction inner side with respect to the release lever. There is a concern in such cases that the strap rotated with respect to the release lever when pull-operated might no longer be able to return to its original position.

An object of the present disclosure is to obtain a seatback lock device capable of suppressing unwanted rotation of a strap with respect to the release lever when pull-operated even in cases in which a strap pull-out opening is arranged displaced to the seat width direction inner side with respect to the release lever, and to obtain a vehicle seat equipped with such a lock device.

A seatback lock device of a first aspect of the present disclosure includes a lock main body that is attached to a side portion of a frame of a seatback coupled so as to be able to tilt forward with respect to a floor section of a vehicle body and that engages with a striker provided at a side portion of the vehicle body, a release lever that is coupled to the lock main body and arranged at a seat width direction inner side with respect to the lock main body, that releases engagement between the lock main body and the striker by being displaced toward a seat upper side, and that also includes a strap coupling portion extending diagonally toward the seat width direction inner side and the seat upper side, and a strap having a one-end portion that is coupled so as to be able to rotate with respect to the strap coupling portion and an other-end side arranged along a height direction of the seatback due to the strap being folded at an obtuse angle at an intermediate portion of the strap, with the other-end portion inserted through a strap pull-out opening formed in a shoulder of the seatback.

In the seatback lock device of the first aspect, the lock main body attached to the frame side portion of the seatback coupled so as to be able to tilt forward with respect to the vehicle body floor section engages with the striker provided at the vehicle body side portion. The release lever arranged at the seat width direction inner side with respect to the lock main body is coupled to the lock main body, and releases engagement between the lock main body and the striker by being displaced toward the seat upper side. The release lever includes the strap coupling portion extending diagonally toward the seat width direction inner side and the seat upper side. The one-end portion of the strap is coupled so as to be able to rotate with respect to the strap coupling portion.

The other-end side of the strap is arranged along the seatback height direction due to the intermediate portion of the strap being folded at an obtuse angle, and the other-end side is inserted through the strap pull-out opening formed in the shoulder of the seatback. Due to the intermediate portion of the strap being folded at an obtuse angle, even in cases in which the strap pull-out opening is arranged displaced to the seat width direction inner side with respect to the release lever, the one-end side of the strap can be arranged diagonally along the strap coupling portion of the release lever while also arranging the other-end side of the strap along the seat height direction. This thereby enables the strap to be suppressed from undergoing unwanted rotation with respect to the strap coupling portion (namely, the release lever) during pull-operation of the strap.

A seatback lock device of a second aspect is the first aspect, wherein the strap coupling portion includes a positioning claw that restricts a rotation range of the strap with respect to the strap coupling portion.

In the seatback lock device of the second aspect, the rotation range of the strap with respect to the strap coupling portion is restricted by the positioning claw provided at the strap coupling portion of the release lever. This thereby enables the strap to be even better suppressed from undergoing unwanted rotation with respect to the strap coupling portion during pull-operation of the strap.

A vehicle seat of a third aspect includes a seat cushion for an occupant of a vehicle to sit on, a seatback that is coupled so as to be able to swing with respect to a vehicle body to support a back of the occupant, and the seatback lock device of the first aspect or the second aspect, wherein the lock main body is provided at a side portion of the seatback, and the strap is inserted into a strap pull-out opening formed in a shoulder of the seatback.

In the vehicle seat of the third aspect, the back of an occupant seated on the seat cushion is supported by the seatback. The seatback is coupled so as to be able to swing with respect to the vehicle body. The lock main body of the seatback lock device is provided at a side portion of this seatback, and the strap of the lock device is inserted through the strap pull-out opening formed in the shoulder of the seatback. This lock device is that of the first aspect or the second aspect, and so the above advantageous effects are exhibited.

As described above, the seatback lock device and vehicle seat equipped with such a lock device of the present disclosure enable a strap to be suppressed from unwanted rotation with respect to a release lever during pull-operation of the strap even in cases in which the strap pull-out opening is arranged displaced to the seat width direction inner side with respect to the release lever.

### BRIEF DESCRIPTION OF THE DRAWINGS

Exemplary embodiments of the present invention will be described in detail based on the following figures, wherein:

FIG. 1 is a front view illustrating part of a vehicle seat according to an exemplary embodiment;

FIG. 2 is a front view illustrating a frame of a seatback and a lock device of a vehicle seat according to an exemplary embodiment;

FIG. 3 is a front view illustrating an enlargement of part of the configuration illustrated in FIG. 2;

FIG. 4 is a front view illustrating a lock device according to an exemplary embodiment;

FIG. 5 is a perspective view illustrating part of a lock device according to an exemplary embodiment;

FIG. 6 is a perspective view illustrating a release lever of a lock device according to an exemplary embodiment;

FIG. 7 is a front view illustrating a lock device according to a comparative example;

FIG. 8 is a perspective view illustrating part of a lock device according to a comparative example; and

FIG. 9 is a perspective view illustrating part of a lock device according to a comparative example, and is a perspective view illustrating a state in which a strap has been rotated with respect to a release lever and not returned to its original position.

### DETAILED DESCRIPTION

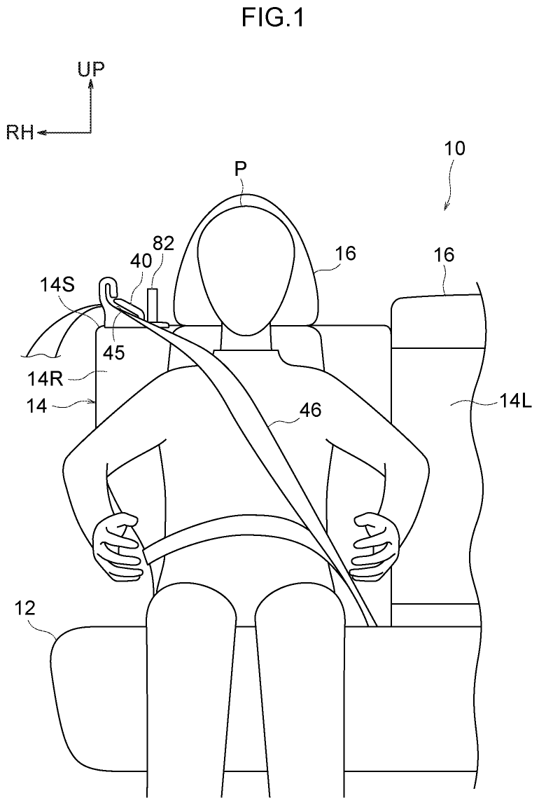

Description follows regarding a vehicle seat 10 according to an exemplary embodiment of the present disclosure, with reference to FIG. 1 to FIG. 6. Note that sometimes in the drawings reference numerals of parts are omitted in order increase readability of the drawings. Moreover, as appropriate in the drawings, the arrows FR, LH, RH, and UP respectively indicate forward, leftward, rightward, and upward directions of the vehicle seat 10. Hereinafter, when reference is simply given to front and rear, left and right, up and down in the following description then this indicates directions with respect to the vehicle seat 10.

As illustrated in FIG. 1, the vehicle seat 10 according to the present exemplary embodiment includes a seat cushion 12 for an occupant to sit on, a seatback 14 to support the back of the occupant, and a headrest 16 to support the head of the occupant. The vehicle seat 10 is, as an example, a three-person rear seat provided with respective headrests 16 at the left-right direction center and both left-right direction sides of an upper end section of the seatback 14 (the left headrest 16 is omitted in the drawings). The front and rear, left and right, and up and down directions of the vehicle seat 10 are aligned with the front and rear, left and right, and up and down directions of the vehicle.

The seatback 14 is divided into a right-side seatback 14R for one person, and a left-side seatback 14L for two people. The right-side seatback 14R and the left-side seatback 14L are each coupled so as to be able to swing with respect to a floor section of a vehicle body through a non-illustrated hinge bracket and are configured so as to be able to tilt forward onto the seat cushion 12.

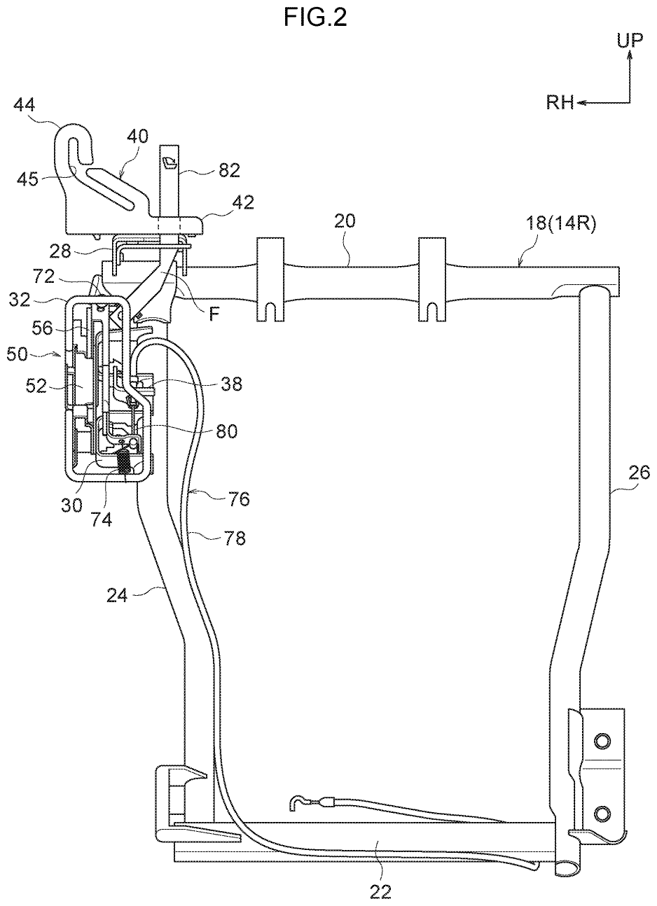

The left-side and right-side seatbacks 14R, 14L are each provided with a lock device 50 (see FIG. 2 to FIG. 5) to restrain the left-side and right-side seatbacks 14R, 14L in an upright position (the position illustrated in FIG. 1, hereafter referred to as “upright position”) to respective side portions of a non-illustrated vehicle body. Each of the lock devices 50 corresponds to a “seatback lock device” of the present disclosure.

Note that configuration in the vicinity of the lock devices 50 in the left-side and right-side seatbacks 14R, 14L is basically configured the same, other than being left-right symmetrical to each other, and so the configuration of the right-side seatback 14R will be described, with description of the configuration of the left-side seatback 14L omitted. Moreover, reference below to front and rear, left and right, up and down directions indicate directions when the seatback 14R is positioned in the upright position.

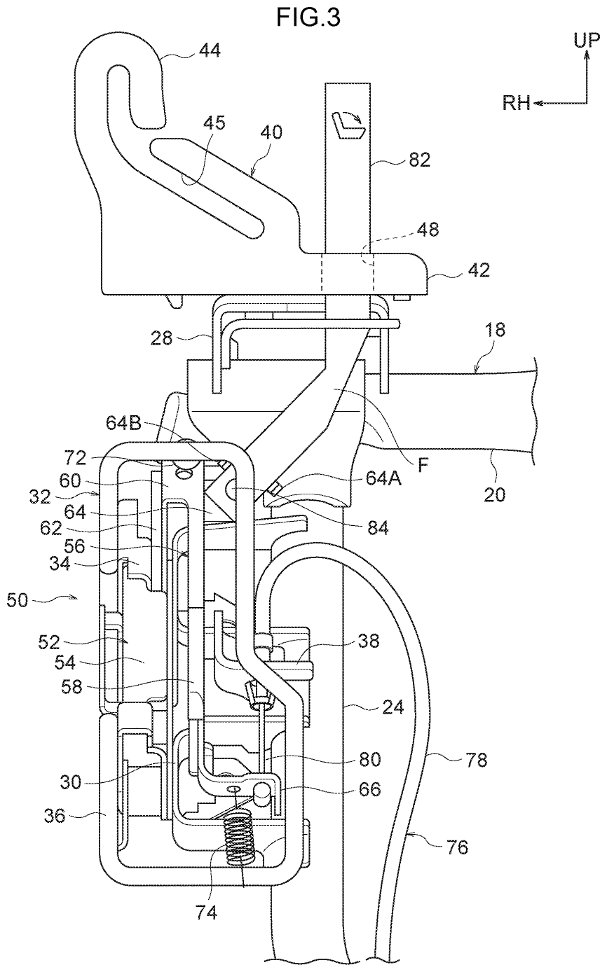

The seatback 14R includes a frame 18 that is a framework member (see FIG. 2 and FIG. 3), a pad (reference numeral omitted) that is a cushion member, and a trim cover (reference numeral omitted) that is a covering. The frame 18 is, for example, configured as a frame shape by joining together metal pipe material and press-formed metal plate blanks. The pad is, for example, configured from a foam body of urethane foam or the like, and is attached to the frame 18. The trim cover is, for example, formed in a bag shape by stitching together plural covering pieces of cloth material, leather, synthetic leather, or the like, and is covered over the seatback pad from the upper side thereof.

The frame 18 includes an upper frame section 20 that extends in the left-right direction at an upper end portion of the seatback 14R, a lower frame section 22 that extends in the left-right direction at a lower end portion of the seatback 14R, a right side frame section 24 that extends in the height direction at the right end of the seatback 14R, and a left side frame section 26 that extends in the height direction at the left end of the seatback 14R.

As illustrated in FIG. 2 and FIG. 3, an upper bracket 28 configured from a press-formed metal plate blank is fixed to a right end portion of the upper frame section 20 of the frame 18, and a lock bracket 30 configured from a press-formed metal plate blank is fixed to an upper portion of the right side frame section 24.

A seatbelt guide 40 is fixed to an upper face of the upper bracket 28. The seatbelt guide 40 is, as illustrated in FIG. 1, provided at a shoulder 14S on the right side of the seatback 14R. The seatbelt guide 40 includes a base 42 fixed to the upper bracket 28 by a means such as bolt fastening or the like, and a belt guide portion 44 that extends upward from the base 42. A slit 45 for insertion of a three-point seatbelt 46 is formed in the belt guide portion 44.

A lock main body 52 of the lock device 50, and a protection frame 32 for front protection of the lock device 50, are fixed to the lock bracket 30. The lock device 50 includes, in addition to the lock main body 52, a release lever 56 and a strap 82. As illustrated in FIG. 3 to FIG. 5, the lock main body 52 includes a housing 54 fixed to the lock bracket 30. The housing 54 is formed in a substantially box shape by joining together plural press-formed metal plate blanks, and is formed in a substantially box shape that has a length direction along the height direction and is flattened in the left-right direction. The housing 54 is fixed to the lock bracket 30 with a means such as bolt fastening or the like.

The protection frame 32 is configured from an attachment bracket 34 fixed to the lock bracket 30 with a means such as bolt fastening or the like, and a wire frame 36 fixed to the attachment bracket 34 with a means such as welding or the like. The attachment bracket 34 is configured from, for example, a press-formed metal plate blank, and the wire frame 36 is configured from bend-processed metal wire material. The wire frame 36 is formed in a rectangular frame shape having a length along the height direction as viewed along the front-rear direction, and is arranged at a front side of the lock device 50.

Mechanism components, such as a non-illustrated latch for engaging with a non-illustrated striker provided at the vehicle body side portion or the like, are housed inside the housing 54 of the lock main body 52. Due to such engagement, the seatback 14R is restricted from swinging with respect to the vehicle body and is restrained in the upright position. These mechanism components include a pawl (omitted in the drawings) for engaging with the latch. The pawl is attached so as to be rotatable with respect to the housing 54. Configuration is such that the engagement of the striker with the latch is released by the pawl being rotated to the seat upper side. Swing restriction of the seatback 14R is release by such engagement release, enabling the seatback 14R to tilt forward onto the seat cushion 12.

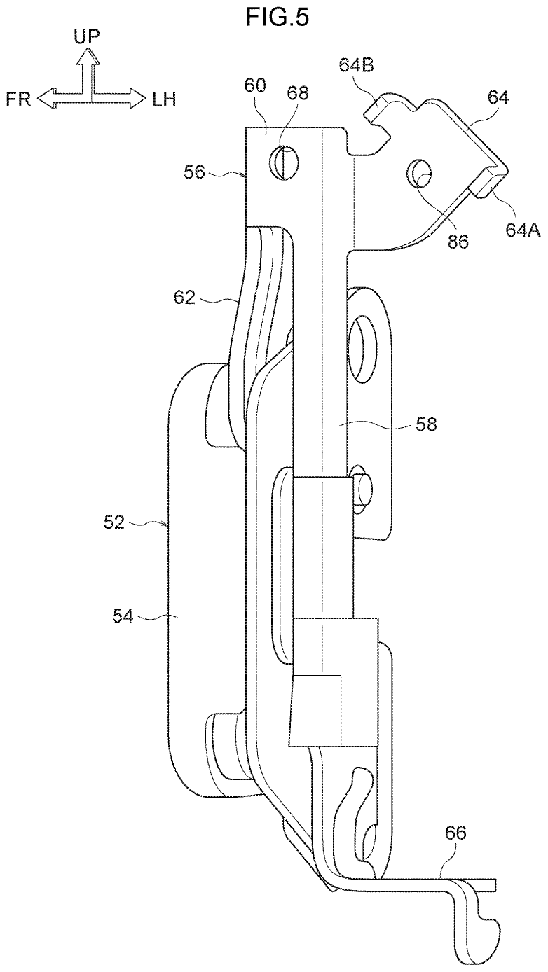

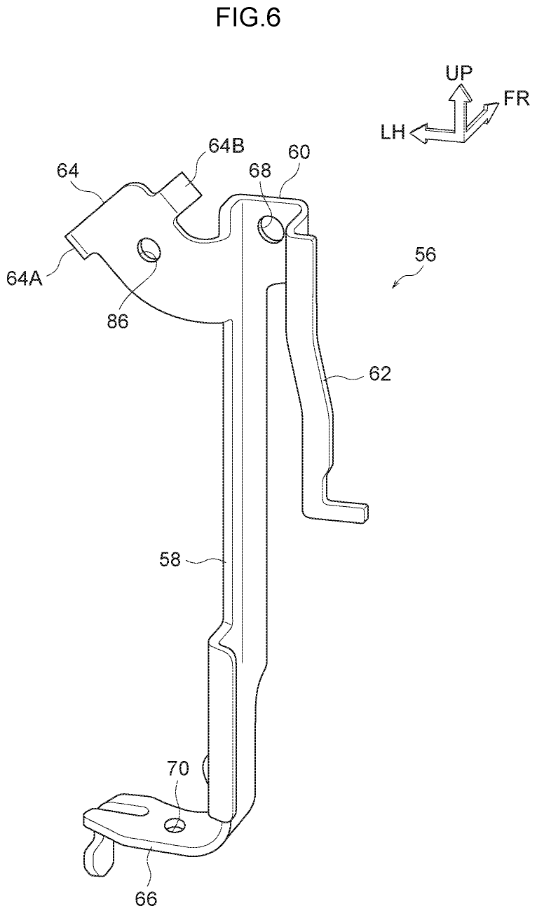

This pawl is coupled to the release lever 56. The release lever 56 is, for example, configured from a press-formed metal plate blank and is arranged at the left side (seat width direction inner side) with respect to the lock main body 52. The release lever 56 is, as illustrated in FIG. 5 and FIG. 6, configured from a lever main body 58 that extends in the height direction at a vicinity of the left side of the lock main body 52, an outside projection 60 that projects from a front edge of an upper end portion of the lever main body 58 toward the right side (seat width direction outer side) and that is bend toward the rear side, a lock coupling portion 62 that extends downward from a leading end portion of the outside projection 60, a strap coupling portion 64 that extends diagonally toward the left side and the upper side from a rear edge portion of an upper end portion of the lever main body 58, and a cable coupling portion 66 extended toward the left side from a lower end portion of the lever main body 58.

Circular shaped through holes 68, 70 are respectively formed in the outside projection 60 and the cable coupling portion 66. One-end portions of respective tension coil springs 72, 74 are anchored to these through holes 68, 70. The other-end portion of the tension coil spring 72 is anchored to an upper end portion of the wire frame 36, and the other-end portion of the tension coil spring 74 is anchored to a lower end portion of the wire frame 36. The release lever 56 is accordingly resiliently supported by the wire frame 36 through the tension coil springs 72, 74.

A lower end portion of the lock coupling portion 62 of the release lever 56 is coupled to the pawl of the lock main body 52. Configuration is such that the pawl of the lock main body 52 rotates upward when the release lever 56 is displaced upward, so as to release engagement between the latch of the lock main body 52 and the vehicle body side striker.

A one-end portion of an inner wire 80 of the remote operation cable 76 is anchored to a leading end portion of the cable coupling portion 66 of the release lever 56. A one-end portion of an outer casing 78 of the remote operation cable 76 is arranged above the cable coupling portion 66, and is anchored to the cable bracket 38 fixed to the right side frame section 24. The cable bracket 38 may, for example, be configured from a press-formed metal plate blank, and is fixed to the right side frame section 24 by a means such as welding or the like. The remote operation cable 76 is, as illustrated in FIG. 2, routed through below the frame 18 to the rear side of the seatback 14R. Configuration is such that the release lever 56 is displaced upward when an other-end portion of the remote operation cable 76 is pull-operated.

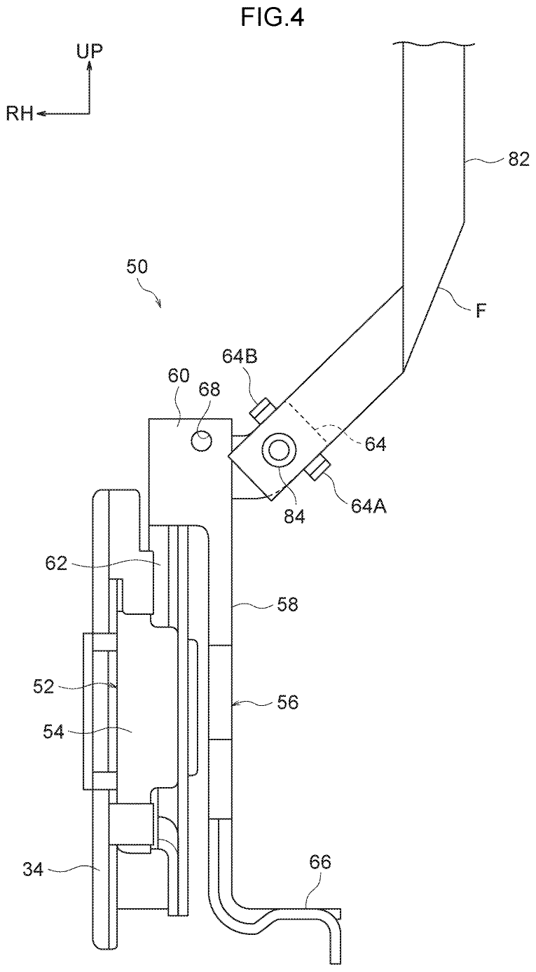

The strap coupling portion 64 of the release lever 56, as an example, extends diagonally at an angle of 45° toward the left side and the upper side from an upper end portion of the lever main body 58. A one-end portion of the strap 82 is coupled to the strap coupling portion 64. The strap 82 is, for example, configured from an elongated strip shaped material made from synthetic fibers or the like, and exhibits flexibility. The one-end portion of the strap 82 is, as illustrated in FIG. 4, coupled to the strap coupling portion 64 using the rivet 84. The rivet 84 passes through a non-illustrated through hole formed in the one-end portion of the strap 82, and through a through hole 86 (see FIG. 6) formed in the strap coupling portion 64, and is arranged orientated with an axial direction along the front-rear direction. The strap 82 is accordingly configured so as to be rotatable about the rivet 84 with respect to the strap coupling portion 64.

Two positioning claws 64A, 64B are formed to the strap coupling portion 64. The one positioning claw 64A is arranged at the left side and lower side with respect to the one-end portion of the strap 82, and the other positioning claw 64B is arranged at the right side and the upper side with respect to the one-end portion of the strap 82. A rotation range of the one-end portion of the strap 82 with respect to the strap coupling portion 64 is accordingly restricted by these positioning claws 64A, 64B to a fixed range.

A fold portion F folded at an obtuse angle (in this case 135°) is provided at an intermediate portion of the strap 82. The other-end side of the strap 82 (namely, locations on the strap 82 further toward the other-end portion side than the fold portion F) is accordingly arranged along the height direction. The other-end side of the strap 82 is inserted through a strap pull-out opening 48 formed in the base 42 of the seatbelt guide 40 (see FIG. 3), and is led out to the upper side of the seatback 14R. The strap pull-out opening 48 is arranged displaced to the left side (seat width direction inner side) with respect to the release lever 56.

The release lever 56 is displaced upward when the other-end side of the strap 82 is pull-operated upward by an occupant. The pawl of the lock main body 52 is thereby rotated upward with respect to the housing 54, in a configuration such that the engagement between the latch of the lock main body 52 and the vehicle body side striker is released.

In the vehicle seat 10 of the above configuration, the back of an occupant seated on the seat cushion 12 is supported by the seatback 14R. The seatback 14R is coupled so as to be able to swing with respect to the vehicle body. The lock main body 52 of the lock device 50 is provided at a side section of the seatback 14R. Swinging of the seatback 14R is restricted by the latch provided at the lock main body 52 being engaged with the striker provided at the vehicle body side portion. The release lever 56 arranged at the left side with respect to the lock main body 52 is coupled to the pawl provided at the lock main body 52, and the engagement between the latch and the striker is released by being displaced upward. This thereby enables the seatback 14R to tilt forward onto the seat cushion 12.

The release lever 56 includes the strap coupling portion 64 extending diagonally to the left side and upper side. The one-end portion of the strap 82 is coupled so as to be able to rotate with respect to the strap coupling portion 64. Due to the strap 82 being folded at an obtuse angle where the fold portion F is provided at an intermediate portion of the strap 82, the other-end side of strap 82 is arranged along the height direction, and the other-end side is inserted through the strap pull-out opening 48 of the seatbelt guide 40. The strap pull-out opening 48 is arranged displaced to the left side with respect to the release lever 56.

Due to the fold portion F provided at the intermediate portion of the strap 82 being folded at an obtuse angle as described above, even in cases in which the strap pull-out opening 48 is arranged displaced to the left side with respect to the release lever 56, the one-end side of the strap 82 can be arranged at an angle along the strap coupling portion 64 of the release lever 56 while still arranging the other-end side of the strap 82 along the height direction. This thereby enables the one-end side of the strap 82 to be suppressed from unwanted rotation with respect to the strap coupling portion 64 (namely, the release lever 56) when the other-end side of the strap 82 is pull-operated by an occupant.

Moreover, in the present exemplary embodiment, the rotation range of the strap 82 with respect to the strap coupling portion 64 is restricted by the positioning claws 64A, 64B provided at the strap coupling portion 64 of the release lever 56. This thereby enables the strap 82 to be suppressed even better from performing unwanted rotation with respect to the strap coupling portion 64 during pull-operation of the strap 82.

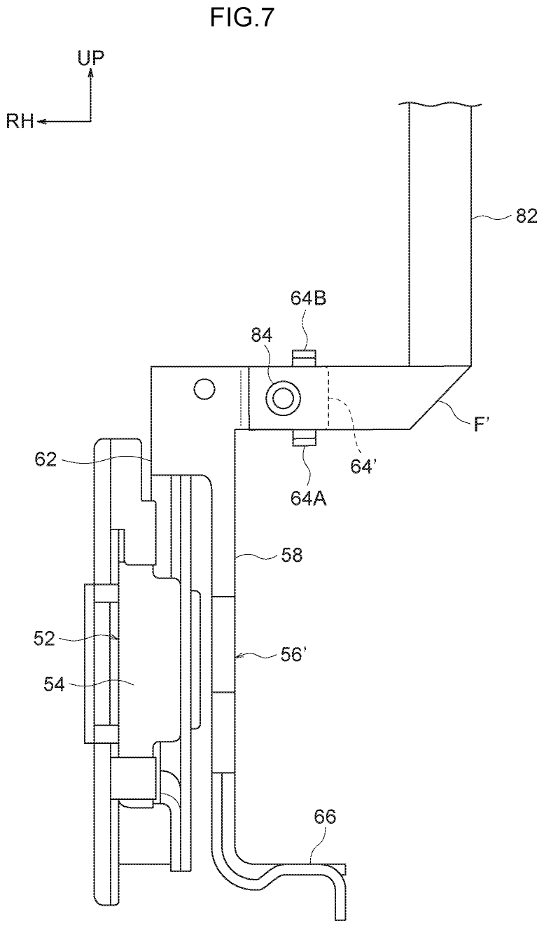

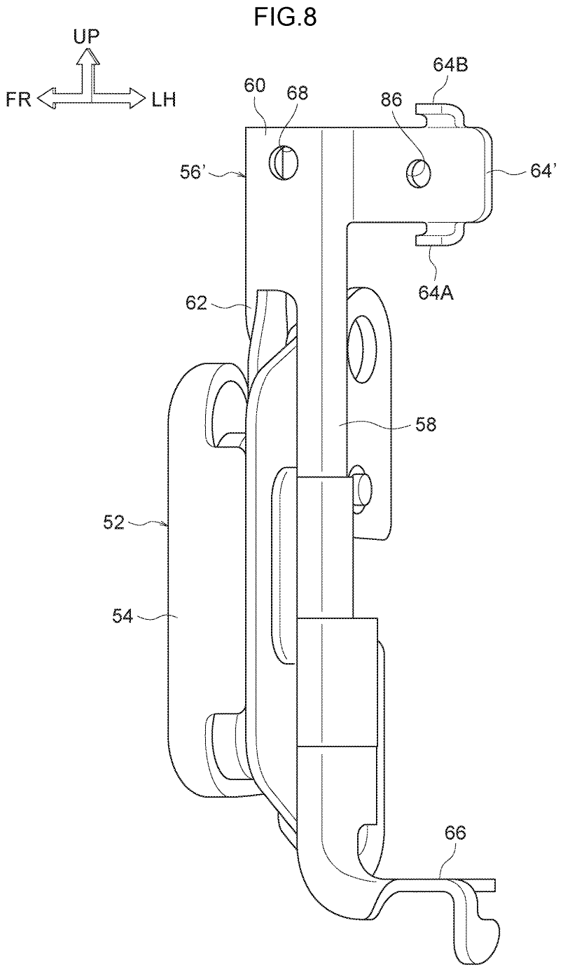

Supplementary description follows of the advantageous effects described above, with reference to a comparative example illustrated in FIG. 7 to FIG. 9. In this comparative example, a strap coupling portion 64′ of a release lever 56′ extends directly toward the left side (the seat width direction inner side) from an upper end portion of a lever main body 58. A strap 82 having a one-end portion coupled so as to be able to rotate with respect to the strap coupling portion 64′ is arranged with the other-end side thereof along the height direction due to the strap 82 being folded at right angles at a fold portion F′ provided at an intermediate portion of the strap 82, and the other-end side of the strap 82 is inserted through a strap pull-out opening 48 formed to a seatbelt guide 40.

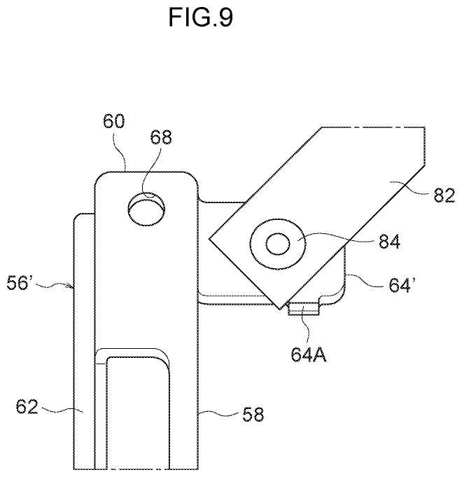

In this comparative example, the other-end side of the strap 82 is rotated with respect to the strap coupling portion 64′ during pull-operation of the other-end side of the strap 82 by an occupant. As a result thereof, as illustrated in FIG. 9, there is a concern that the one-end portion of the strap 82 might catch on a positioning claw 64B of the strap coupling portion 64′ and not be able to return to its original position, however, the present exemplary embodiment is able to avoid such an issue.

Moreover, in the present exemplary embodiment, due to the positioning claws 64A, 64B being provided at the strap coupling portion 64, the orientation of the strap 82 to be clear as it is attached to the strap coupling portion 64, readily preventing mis-assembly of the strap 82 to the strap coupling portion 64. Furthermore, in the present exemplary embodiment, the one-end portion of the strap 82 is coupled to the strap coupling portion 64 using a single rivet 84, enabling the number of components and workload to be reduced compared to cases in which two rivets 84 are employed.

Moreover, in the above comparative example, due to the positional relationship between the release lever 56 and the other-end side of the strap 82, a moment arises at the fold portion F′ during pull-operation of the strap 82. As a result thereof, due to the fold portion F′ of the strap 82 transitioning from a right angle to an obtuse angle, not only does this worsen the transmission efficiency of force transmitted from the strap 82 to the release lever 56, but the amount by which the strap 82 is pulled to the outside of the seatback 14R from the strap pull-out opening 48 also becomes longer. Regarding this point, in the present exemplary embodiment the fold portion F of the strap 82 is already folded at an obtuse angle, and so any change in the angle of the fold portion F during pull-operation of the strap 82 is reduced. This thereby enables the transmission efficiency of force transmitted from the strap 82 to the release lever 56 to be prevented or suppressed from becoming worse, and enables the pulled out amount of the strap 82 to be prevented or suppressed from becoming longer, as there were in the comparative example.

Note that although in the above exemplary embodiment a case has been described in which the vehicle seat 10 is configured with a right side section and a left-right direction central section of a three-person rear seat, there is no limitation thereto. In cases in which the vehicle seat 10 according to the present disclosure is configured by a left side section and a left-right direction central section of a three-person rear seat, the configuration is left-right symmetrical to the exemplary embodiment described above. Moreover, the seatback of the vehicle seat according to the present disclosure is not limited to being a dividable seat.

Moreover, although in the above exemplary embodiment a case has been described in which the present disclosure is applied to the vehicle seat 10, there is no limitation thereto, and the present disclosure is applicable to a transportation seat other than in a vehicle (such as in an aircraft or a ship).

In addition thereto, various other modifications may be implemented for the present disclosure within a range not departing from the spirit thereof. Moreover, obviously the scope of rights of the present disclosure is not limited to the above exemplary embodiment.

What is claimed is:

1. A seatback lock device comprising:
a lock main body that is attached to a side portion of a frame of a seatback coupled so as to be able to tilt forward with respect to a floor section of a vehicle body and that engages with a striker provided at a side portion of the vehicle body;
a release lever that is coupled to the lock main body and arranged at a seat width direction inner side with respect to the lock main body, that releases engagement between the lock main body and the striker by being displaced toward a seat upper side, and that includes a strap coupling portion extending diagonally toward the seat width direction inner side and the seat upper side; and
a strap having a one-end portion that is coupled so as to be able to rotate with respect to the strap coupling portion and an other-end side arranged along a height direction of the seatback due to the strap being folded at an obtuse angle at an intermediate portion of the strap, with the other-end portion inserted through a strap pull-out opening formed in a shoulder of the seatback.

2. The seatback lock device of claim 1, wherein the strap coupling portion includes a positioning claw that restricts a rotation range of the strap with respect to the strap coupling portion.

3. A vehicle seat comprising:
a seat cushion for an occupant of a vehicle to sit on;
a seatback that is coupled so as to be able to swing with respect to a vehicle body to support a back of the occupant; and
the seatback lock device of claim 1, wherein the lock main body is provided at a side portion of the seatback, and the strap is inserted into a strap pull-out opening formed in a shoulder of the seatback.
